(19) United States
(12) Patent Application Publication
(10) Pub. No.: US 2014/0027132 A1
(43) Pub. Date: Jan. 30, 2014

(54) Hypoxic Fire Prevention System, Building Provided Therewith and Method Therefor

(71) Applicants: Antoon Siefko Oosterhuis, Heerenveen (NL); Hans Hendrik Wolters, Leeuwarden (NL)

(72) Inventors: Antoon Siefko Oosterhuis, Heerenveen (NL); Hans Hendrik Wolters, Leeuwarden (NL)

(73) Assignees: TRIPLE H B.V., Leeuwarden (NL); A.S. OOSTERHUIS BEHEER B.V., Heerenveen (NL)

(21) Appl. No.: 13/979,470

(22) PCT Filed: Jan. 12, 2012
(86) PCT No.: PCT/NL12/50020

§ 371 Date: Oct. 4, 2013

(30) Foreign Application Priority Data
Jan. 12, 2011 (NL) 2005991

(51) Int. Cl. A62C 3/02; A62C 99/00

(52) U.S. Cl. CPC A62C 3/02; A62C 99/009
USPC 169/45; 169/11

(57) ABSTRACT

The present invention relates to a hypoxic fire prevention system and building construction and method therefor. The hypoxic fire prevention system comprises: a central supply container for hypoxic gas; a number of compartments connected to the container via connecting conduits; and at least one distributor provided in each compartment and operatively connected to a connecting conduit for the purpose of distributing the hypoxic gas.

The invention relates to a hypoxic fire prevention system for combatting or preventing fire by realizing hypoxic conditions, more specifically a reduced oxygen concentration compared to normal air.

Diverse fire prevention systems are known in practice. Some of these systems aim to reduce temperature, for instance by supplying water as extinguishing agent. A drawback of these systems, including also sprinkler systems, is that there is relatively great consequential damage. In other systems oxygen is removed, for instance by smothering the fire with a fire blanket. It is also known to use hypoxic conditions, i.e. reducing the oxygen content, in order to thereby smother the fire. A drawback here is that such conditions have to be provided in each space so as to be able to realize the hypoxic conditions at the desired moments when a fire is detected. This is, among other things, an expensive system, particularly in already existing buildings.

An object of the invention is to solve or to reduce said problems.

This object is achieved with the hypoxic fire prevention system according to the invention, the system comprising:
a central supply container for hypoxic gas;
a number of compartments connected to the container via connecting conduits; and
at least one distributor provided in each compartment and operatively connected to the connecting conduit for the purpose of distributing the hypoxic gas.

A central system is realized by providing a central supply container for the hypoxic gas. In the context of the present invention hypoxic gas is understood to mean a gas, particularly air, with a low oxygen content, for instance pure nitrogen. When applied in for instance a residential area it will be possible to provide such a supply container centrally in the residential area. From here the diverse compartments are connected to the supply container. By providing the individual compartments with at least one distributor per compartment, the connecting conduits can supply the hypoxic gas to at least one distributor in a separate compartment. This achieves that a supply container for the hypoxic gas need not be provided per individual compartment. Owing to the simple incorporation of the components such a central system has advantages in already existing buildings or residential areas, and particularly in new housing. In addition, a plurality of compartments can use the same supply container, whereby the supply can remain smaller than compared to conventional systems in which a supply must be provided per application.

Surprisingly, it has been found that the system according to the invention can be applied in effective manner in the case the compartment comprises an open space. Conventional fire prevention is usually based on a closed space. According to the present invention however, the system according to the invention can be applied to open spaces. Such an open space preferably comprises a sub-space in which the system is active. An open space is for instance a stadium or stand. In this case the sub-space is the immediate vicinity of for instance a seat. It has been found that the system according to the invention can particularly influence the conditions in a sub-space in effective manner such that fire is combatted and/or fire prevention can be implemented, for instance in the case of work operations.

In a currently preferred application the compartment, preferably the sub-space, comprises one or more seats. This is relevant for instance in the case of a stadium, aircraft, train or theatre. It has been found that, by providing such a compartment, for instance an individual seat or a group of seats, with a distributor or other outflow opening, the conditions at the position of the compartment can be made hypoxic. The detected fire is hereby extinguished in the compartment by being smothered. Surprisingly, it has been found here that it is readily possible to locally provide individual compartments with hypoxic conditions without the whole space, for instance the whole stadium or the whole house, having to be set to these conditions. This enables an effective combatting of fire and possible preventive action.

In an advantageous preferred embodiment a compartment comprises an individual house in a residential area, a building or other building construction. It is hereby possible to provide the centrally located supply container centrally with gas and/or inspect it without being dependent on the residents of such a house. A further additional advantage is that an existing house does not need to be converted in order to provide a hypoxic supply container. This has the additional advantage that the capacity of the central container in the residential area can be smaller than the sum of the alternative individual supply containers per house. This limits installation costs. A particular additional advantage here is that, although the overall capacity is lower due to the use of the central system, in the case of emergency in one of the compartments the supply of hypoxic gas available is considerably greater than when in alternative manner a container is provided per compartment. This greater availability of hypoxic gas achieves a greater degree of safety.

In a currently preferred embodiment the distributors in the compartments are operatively connected to a climate control system in the house or other structure in which hypoxic gas can be supplied in the case of emergency from the supply container to the climate control system using connecting conduits. The advantage of this connection between the central supply container and the often already existing climate control systems in houses is that a safe system can be realized in effective manner without excessive installation costs. Hypoxic gas is hereby carried to the desired position in case of emergency, or preventively.

In an advantageous preferred embodiment according to the present invention the oxygen concentration in the container and/or the conduits is lower than about 16% and higher than about 13%.

At a lowered oxygen concentration, preferably in the range of 13-16%, it has been found that the sources of fire are smothered while persons can breathe in relatively normal manner. As lower limit use is preferably made of the minimum oxygen percentage which is still harmless to people. The prevention system according to the invention is hereby not life-threatening. Surprising here is that these lowered oxygen concentrations need only be realized at local positions and not in the whole space. By reducing the oxygen concentrations to only limited extent, for instance to the stated range of 13-16%, it is possible to supply the gas from the supply container at high speed since no life-threatening situations are hereby created. This in contrast to supplying gas with extremely low oxygen concentrations of less than about 10%. Owing to the relatively high supply speed of gas with an oxygen concentration in the range of 13-16% the locally desired hypoxic conditions are realized in a very short time, whereby the fire is smothered and people who are possibly present are not harmed. It will be apparent that this high speed enhances the overall safety of the compartment and the whole building, residential area or other compartment in which the central hypoxic fire prevention system according to the invention is provided.

A further additional advantage is that dangerous gases can be dissipated relatively quickly by employing a relatively high flow speed. Separate fans employed in practice and used for this reason are hereby unnecessary. Also avoided is that additional oxygen is supplied to the source of the fire by these separate fans. As an illustrative example, several hundred cubic metres per hour can be introduced into a space with an outflow opening provided with a diameter of about 150 mm, preferably such that there is full circulation through the volume of the space in question once in for instance 30 seconds.

The supply container is preferably a pressure container suitable for a pressure of at least 12 bar, preferably at least 13 bar, more preferably at least 16 bar, and most preferably at least 100 or 200 bar. A desired flow speed can hereby be realized with the above stated advantages. At a higher pressure, for instance at least 100 or at least 200 bar, it is possible to suffice with a smaller volume of the pressure container.

In an advantageous preferred embodiment according to the present invention the connecting conduits in the system are provided with a gas sensor for at least periodic measurement of the conditions in the conduit.

Providing a gas sensor achieves that the quality of the system is at least periodically monitored. This is possible for instance by placing a sensor in a so-called at-line arrangement such that a sample of the gas present in the conduits is measured from time to time.

Alternatively or additionally, it is possible to place a sensor in a separate outflow, for instance in the form of a small leakage at an outlet, whereby the quality of the gas in the conduits can be monitored more or less continuously.

In this manner it is possible to guarantee that the system will also actually work in the case of emergency. This is a particular advantage in fire prevention systems in general, since most systems are only little used and are usually subject to limited inspection. A good operation of the prevention system can therefore save lives.

In a further advantageous preferred embodiment according to the invention a mixing valve is provided at the conduits for admixing outside air.

Providing a mixing valve achieves that the oxygen concentration present in the conduits and/or in the supply container can be manipulated. Additionally or alternatively to storing gas already present in the supply container at desired conditions, this enables an effective control of the gas conditions in the container, or more particularly in the conduits, whereby the gas conditions applied in compartments can be controlled and adjusted. It is thus possible for instance to provide the storage container with a gas without oxygen and subsequently admix a low percentage of oxygen during use. This considerably increases the quantity of effectively usable gas.

In a further advantageous preferred embodiment according to the present invention the system comprises a gas generator for conditioning the supply container.

By providing the central supply container with a gas generator with which inert gas can be produced it is possible to provide a substantially self-sufficient fire prevention system. After use of the system, wherein gas from the storage container is consumed, it is in this way possible using this device to replenish the supply of gas. Such a device is for instance a nitrogen membrane, wherein the membrane provides for separation of the supplied air into water vapour, oxygen, CO₂ and nitrogen. Nitrogen does not permeate the membrane here, or at least only with difficulty. The gas supply in the container can be replenished herewith. Other devices are otherwise also possible.

In a further advantageous preferred embodiment according to the present invention the system further comprises an alarm system.

By providing the system with an alarm system, an alarm signal can be generated. This signal is for instance for the users of a compartment where a fire is detected. Additionally or alternatively, the signal can be sent to the fire service and/or other emergency services. The alarm system can also take further actions, for instance switching off electricity supply and/or gas supply to the compartment. Safety is in this way further increased.

In a further particular preferred embodiment according to the present invention the system comprises a free connection suitable for coupling of additional conduits.

Providing a separate, free connection achieves that compartments not directly, or continuously, connected to the system can also make use of the system in case of emergency. The fire service can for instance make a temporary connection here between the free connection and the relevant compartment. This further enhances the flexibility and applicability of the system.

The invention further relates to a residential area, industrial estate or other building construction provided with a hypoxic fire prevention system as described above.

Such a building construction provides the same advantages and effects as described for the fire prevention system. In addition to a residential area or industrial estate, such an construction can also comprise a stadium, train, aircraft, theatre or other constructions such as a prison, hospital or care home.

The invention further also relates to a method for hypoxic fire prevention, including preventive action, making use of the above stated hypoxic fire prevention system.

The method provides the same advantages and effects as described for the fire prevention system and/or the building construction.

The oxygen concentration added to the gas preferably lies in the range of about 12-18% and preferably amounts to about 13-16%. The stated advantages are hereby realized, including supply of the gas to a source of fire at relatively high speed and not harming people who may still be present in the compartment.

The method preferably also comprises of optionally admixing outside air. This achieves the possibility of controlling and/or regulating the conditions in the container or the conduits. This further increases safety.

The fire prevention system and the method for hypoxic fire prevention are described above with particular reference to a detected fire. According to the invention it is also possible to utilize the same system and method in preventive manner, for instance by periodically realizing hypoxic conditions in a house during holiday periods.

Further advantages, features and details of the invention are elucidated on the basis of preferred embodiments thereof, wherein reference is made to the accompanying drawings, in which:

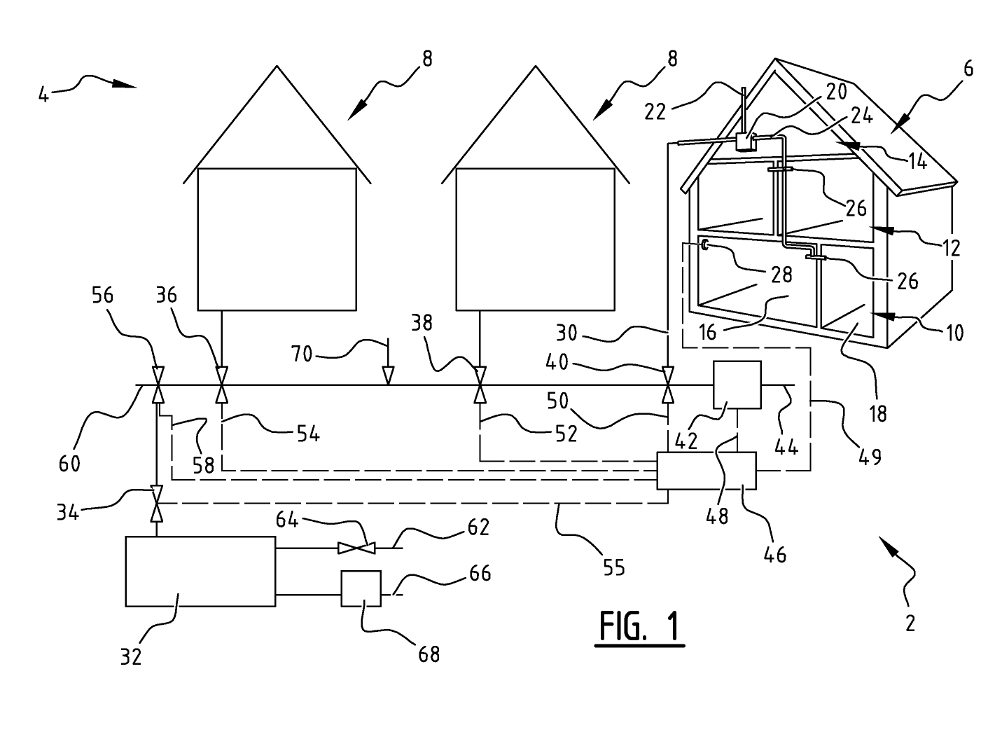

FIG. 1 shows an overview of the system according to the present invention;

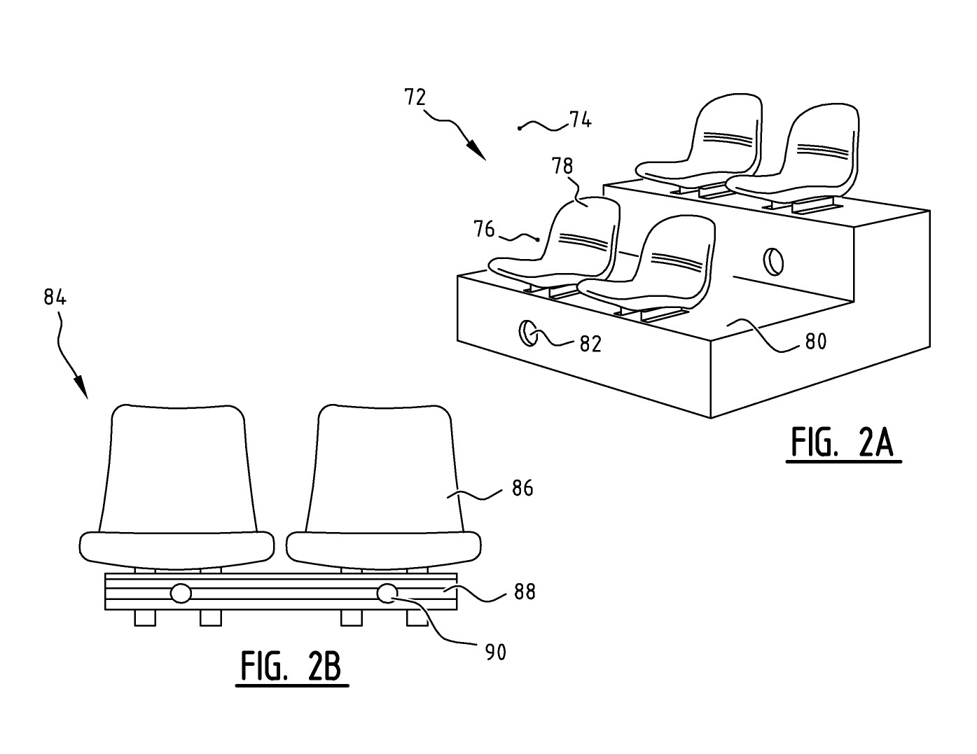

FIGS. 2A and B show a view of an open system according to the invention.

A hypoxic fire prevention system 2 (FIG. 1) is applied in the shown embodiment in a residential area 4 with a first house 6 and a number of further houses 8. House 6 has a ground floor 10, first floor 12 and an attic 14. A first room 16 and a second room 18 are situated on ground floor 10. A climate control 20 is provided in attic 14, wherein a discharge 22 is provided which connects climate control system 20 to the outside environment. Further provided is a conduit 24 which connects climate control 20 to blow-out openings 26 in rooms 16, 18. In the shown embodiment the individual rooms are provided with a fire detector 28, for instance in the form of a detector of heat, carbon monoxide, gases etc.

Climate control 20 of the climate control system in house 6 is operatively connected to a supply container 32 using supply conduit 30. Supply container 32 is provided for this purpose with a closing valve 34. Separate closing valves 36, 38 form a connection to the separate houses 8, and closing valve 40 to house 6. A sensor 42 is further provided in an outlet 44 for measuring the gas conditions prevailing in the conduits connected to container 32.

Controller 46 receives a measuring signal 48 from sensor 42 concerning the current gas conditions. In case of emergency central controller 46 receives a signal 49 from fire detector 28. Controller 46 analyses the data and then sends control signals 50 to closing valve 40, control signal 52 and 54 to closing valves 38 and 36, and control signal 55 to closing valve 34.

Provided in the shown embodiment is closing valve 56 which can be controlled via control signal 58 from controller 46. Connected to closing valve 56 is an inlet 60 for admitting outside air in order to thereby regulate the oxygen concentration in the conduits of container 32. In order to fill container 32 an inlet 62 with closing valve 64 is provided in the shown embodiment. Hypoxic gas can for instance be hereby supplied using a truck. Alternatively or additionally, a second inlet 66 is provided which is connected to generator 68, for instance a nitrogen membrane, for thereby generating the desired conditions in container 32. If desired, an outlet (not shown) can be provided to prevent undesired build-up of pressure in the system. Also provided in the shown embodiment is a free connection 70 to which the fire service can for instance connect a conduit to a building not directly connected to the central system.

An open hypoxic fire prevention system 72 (FIG. 2A) is provided in open space 74. A number of seats 78 are placed on a stand 80 in sub-space 76 of open space 74. Stand 80 is for instance a part of a football stadium. In the case a fire or an increased fire risk is detected, gas with no or preferably a low oxygen content is blown out of opening 82. Sub-space 76 is hereby provided with gas conditions in which fire is extinguished or prevented, while conditions in sub-space 76 are preferably such that people are not in danger.

An alternative open hypoxic fire prevention system 84 (FIG. 2B) is provided with a number of seats 86 with a support or pipe 88 with which gas can be supplied. Pipe 88 is provided with an outflow opening 90.

If desired, the open system 72, 84 can be supplied from central tank 32, optionally with the same and/or similar components as shown for system 2.

In the case a fire 28 is detected or in the case other preventive action is desired, a signal is received by controller 46. This can be received from fire detector 28 or a time switch. Closing valve 34 of container 32 is then opened and, at least in the shown embodiment, closing valves 56, 36, 38 and 40 are set in a position whereby gas can be carried from container 32 to climate control 20 of the climate control system in house 6. The hypoxic gas is subsequently carried by climate control 20 from the climate control system via conduit 24 to the desired blow-out opening 26 in sub-compartment or room 16. It is in this way possible to combat the fire and/or take the desired preventive action. It is thus possible to not only take the preventive action during a holiday period but to also take it for instance during work operations, which for instance include welding, with a determined fire risk.

The present invention is by no means limited to the above described preferred embodiments thereof. The rights sought are defined by the following claims, within the scope of which many modifications can be envisaged.

1. A hypoxic fire prevention system, comprising:
a central supply container for hypoxic gas;
a number of compartments connected to the container via connecting conduits; and
at least one distributor provided in each compartment and operatively connected to a connecting conduit for the purpose of distributing the hypoxic gas.

2. The hypoxic fire prevention system as claimed in claim 1, wherein the compartment comprises an open space.

3. The hypoxic fire prevention system as claimed in claim 2, wherein the open space comprises a sub-space.

4. The hypoxic fire prevention system as claimed in claim 3, wherein the sub-space comprises one or more seats.

5. The hypoxic fire prevention system as claimed in claim 1, wherein the compartment comprises a house, a building or other building construction.

6. The hypoxic fire prevention system as claimed in claim 1, wherein the compartment is provided with a climate control system operatively connectable to the conduits with connecting means.

7. The hypoxic fire prevention system as claimed in claim 1, wherein the oxygen concentration in the container and/or the conduits is lower than about 16% and higher than about 13%.

8. The hypoxic fire prevention system as claimed in claim 1, wherein the supply container is a pressure container suitable for a pressure of at least 12 bar, preferably at least 13 bar, more preferably at least 16 bar, and most preferably at least 100 or 200 bar.

9. The hypoxic fire prevention system as claimed in claim 1, wherein a gas sensor is provided in or close to the connecting conduits for at least periodic measurement of the conditions in the conduit.

10. The hypoxic fire prevention system as claimed in claim 1, wherein a mixing valve is provided in or at the conduits for admixing outside air.

11. The hypoxic fire prevention system as claimed in claim 1, further comprising a gas generator for conditioning the supply container.

12. The hypoxic fire prevention system as claimed in claim 1, further comprising an alarm system.

13. The hypoxic fire prevention system as claimed in claim 1, further comprising a free connection suitable for coupling of additional conduits.

14. A residential area, industrial estate or building construction provided with a hypoxic fire prevention system as claimed in claim 1.

15. A method for hypoxic fire prevention, comprising of:
detecting an incipient fire or an increased risk thereof in a compartment; and
supplying hypoxic gas to the compartment such that at least the local conditions become at least partially hypoxic.

16. The method as claimed in claim 15, wherein the supplied gas has an oxygen concentration in the range of 12-18% and preferably about 13-16%.

17. The method as claimed in claim 15, wherein the supply comprises of admixing outside air.
